(19) United States
(12) Patent Application Publication
(10) Pub. No.: US 2017/0155697 A1
(43) Pub. Date: Jun. 1, 2017

(54) METHOD AND DEVICE FOR PROCESSING STREAMING MEDIA

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Peng Cang, Tianjin (CN)

(21) Appl. No.: 15/249,109

(22) Filed: Aug. 26, 2016

Related U.S. Application Data
(63) Continuation of application No. PCT/CN2016/089274, filed on Jul. 7, 2016.

(30) Foreign Application Priority Data
Dec. 1, 2015 (CN) 201510870437.5

(51) Int. Cl. H04L 29/06; H04L 29/08

(52) U.S. Cl. CPC H04L 65/4092; H04L 67/02; H04L 65/4084

(57) ABSTRACT

An embodiment of the present disclosure discloses a method and a device for processing streaming media. The method comprises: receiving time shifting instructions coming from users in a process of playing streaming media files, wherein the time shifting instructions comprise a target time point; determining TS (Transport Stream) segments corresponding to the target time point according to index files of the segments corresponding to the streaming media files; determining location information of a key frame closest to the target time point in the TS segments; playing the TS segments from the location information of the key frame. According to the embodiment of the present disclosure, the TS segments can be directly played from the key frame closest to the target time point of time shifting, so that the time shifting accuracy can be improved in a process of playing the streaming media files.

### CROSS-REFERENCE TO RELATED APPLICATIONS

The present disclosure is a continuation of International Application No. PCT/CN2016/089274 filed on Jul. 7, 2016, which is based upon and claims priority to Chinese Patent Application No. 201510870437.5, entitled “METHOD AND DEVICE FOR PROCESSING STREAMING MEDIA”, filed on Dec. 1, 2015, the entire contents of all of which are incorporated herein by reference.

### FIELD OF TECHNOLOGY

The present disclosure generally relates to the technical field of streaming media, in particular to a method and a device for processing media.

### BACKGROUND

With the continuous development of streaming media technology and network technology, users can watch various videos on terminal devices over network, and online videos have become an integral part of our daily life.

In a process of implementing the present disclosure, the inventor discloses that at present, video websites usually transmit online video files via HLS (HTTP Live Streaming) streaming media transmission protocol. A huge capacity of online video files are segmented into a large numbers of TS (Transport Stream) segments via HLS on servers, so as to be transmitted on Internet, and m3u8 index files are generated to record sequence and duration of each TS segment. The TS segments are downloaded and played via the index files. Generally, the durations of the TS segments are usually fixed or equal to each other, for example, if the durations of the TS segments of some online video file with total 10 min duration are 10 s, the online video file can be segmented into 60 TS segments.

When the users watch the online videos on the terminal devices, time shifting function is usually enabled, namely playing the videos from the appointed time in a manner of dragging a playing progress bar. Taking the 10 min duration of the online video as an example, if the users drag the playing progress bar to a location at 25 s, the terminal devices will request the TS segments corresponding to the location at 25 s to the servers, however, the transmission unit of HLS is the segment, thus under the condition above, the segments returned to the terminal devices by the server begins from the location at 20th second, and the terminal devices begin to play the network video from the location at 20th second. Therefore, current time shifting schemes have a certain error, and accurate time shifting cannot be achieved.

### SUMMARY

An embodiment of the present disclosure discloses a method and a device for processing streaming media. According to the method and the device, shortcomings that current time shifting schemes have a certain error and accurate time shifting cannot be achieved can be overcome, so as to improve the accuracy of time shifting.

According to an embodiment of the present disclosure, there is provided a method for processing streaming media, comprising: at an electronic device:

receiving a time shifting instruction sent from a user in a process of playing a streaming media file, wherein the time shifting instruction comprises a target time point;

determining a TS segment corresponding to the target time point according to an index file of the segment corresponding to a streaming media file;

determining location information of a key frame closest to the target time point in the TS segment;

playing the TS segment from the location information of the key frame.

According to an embodiment of the present disclosure, there is provided an electronic device, comprising: at least one processor; and a memory communicably connected with the at least one processor for storing instructions executable by the at least one processor, wherein execution of the instructions by the at least one processor causes the at least one processor to:

receive a time shifting instruction sent from a user in a process of playing a streaming media file, wherein the time shifting instruction comprises a target time point;

determine a TS segment corresponding to the target time point according to an index file of the segment corresponding to a streaming media file;

determine location information of a key frame closest to the target time point in the TS segment; and

play the TS segment from the location information of the key frame.

According to an embodiment of the present disclosure, there is provided a computer program comprises computer-readable codes; when the computer-readable codes run on a server, the server carries out the method for processing the streaming media above.

According to an embodiment of the present disclosure, there is provided a non-transitory computer-readable medium storing executable instructions that, when executed by an electronic device, cause the electronic device to:
receive a time shifting instruction sent from a user in a process of playing a streaming media file, wherein the time shifting instruction comprises a target time point; determine a TS segment corresponding to the target time point according to an index file of the segment corresponding to a streaming media file; determine location information of a key frame closest to the target time point in the TS segment; and play the TS segment from the location information of the key frame.

According to the method for processing the streaming media and the device for processing the streaming media in the present disclosure, according to a time point of the time shifting appointed by a user and index file of segment, location information of the corresponding TS segment and key frame closest to the time point of the time shifting in the TS segment can be determined, thereby directly playing the TS segment from the location information. As compared to play the TS segment from head of the TS segment in prior art, according to the embodiment of the present disclosure, the TS segments can be directly played from the key frames closest to the time point of the time shifting, thus the accuracy of the time shifting can be improved in a process of playing streaming media files. In addition, according to the embodiment of the present disclosure, the key frame closest to a target time point can be directly positioned. The key frame can be separately decoded and played, rather than decoding from the head of the TS segment, thereby improving the decoding efficiency.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow chart of a method for processing streaming media in accordance with some embodiments.

FIG. 2 is a step flow chart of a method for processing streaming media in accordance with some embodiments.

FIG. 3 is a step flow chart of a method for processing streaming media in accordance with some embodiments.

FIG. 4 is a structure diagram of a device for processing streaming media in accordance with some embodiments.

FIG. 5 is a schematic diagram of an electronic device for carrying out the method in accordance with some embodiments.

FIG. 6 is a schematic diagram of a storage unit for maintaining or carrying a program code in accordance with some embodiments.

### DESCRIPTION OF THE EMBODIMENTS

In order to clarify the objectives, technical schemes and advantages of the embodiments of the present disclosure, the technical schemes in the embodiments of the present disclosure are described clearly and integrally in a way that combines the drawings in the embodiments of the present disclosure. Obviously, the embodiments described are some embodiments of the present disclosure, rather than all embodiments. Based on the embodiments of the present disclosure, all of the other embodiments obtained by a person skilled in the art without creative work are within the protection scope of the present disclosure.

### Embodiment 1

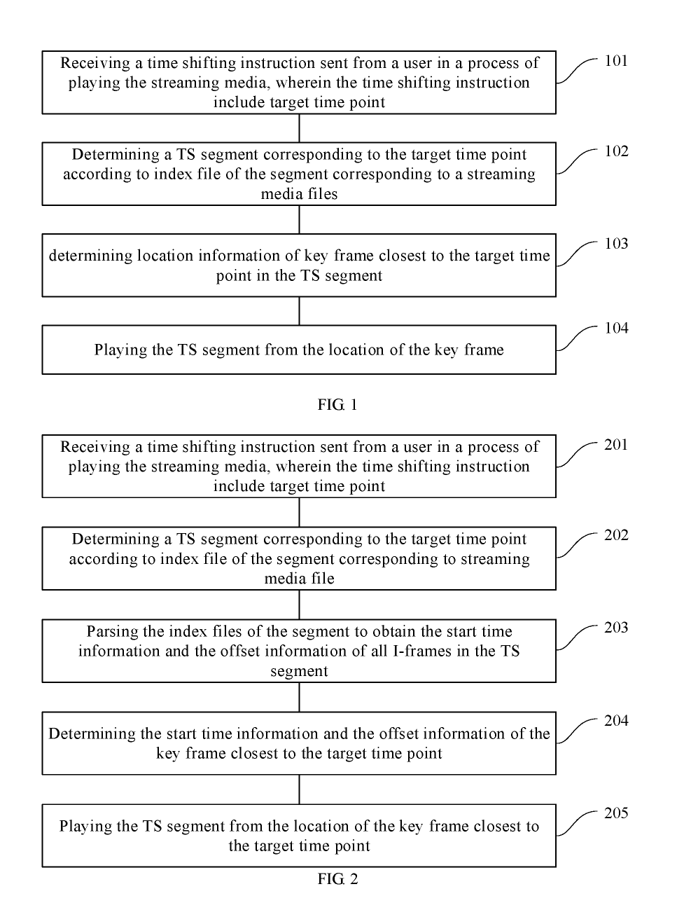

A step flow chart of a method for processing streaming media according to a first embodiment of the present disclosure is shown in FIG. 1. The method for processing the streaming media specifically includes steps as follows.

Step 101: receiving a time shifting instruction sent from a user in a process of playing a streaming media file, wherein the time shifting instruction comprises a target time point.

The embodiment of the present disclosure is applicable to any terminal device capable of playing the streaming media file. The terminal devices include: cell phones, smart phones, laptop computers, PC (Personal Computer), E-books terminals, digital broadcasting terminals, PDA (Personal Digital Assistant), smart televisions, portable multimedia players or navigation systems. It is understood that the embodiment of the present disclosure does not request specific terminal devices. The streaming media mean formats of media such as audio/video played on Internet in a manner of stream transmission adopt the formats of the media such as audio, video or multi-media files played on Internet in a manner of stream transmission. To conveniently illustrate, the present disclosure is described by taking the video as an example, application scenarios in other formats can be referred to each other.

In a process of playing the streaming media file on the terminal device, the users can send the time shifting instruction, namely dragging the playing progress bar to play the streaming media file from the specified target time point.

Step 102: determining a TS segment corresponding to the target time point according to an index file of the segment corresponding to a streaming media file.

According to HLS protocol, the streaming media file is composed of a plurality of TS segments according to a time sequence, sequence and duration of each TS segment are recorded in the index file of the segment (m3u8 index files). The total duration of the streaming media file and the duration of each TS segment can be obtained via the m3u8 index file. Usually, the duration of the TS segment are fixed or equal to each other, thus the TS segment corresponding to the target time point can be determined according to the total duration of the streaming media file and the duration of each TS segment.

According to a preferable embodiment of the present disclosure, the index file of the segment includes: the duration information of the TS segment.

The step of determining TS segment corresponding to a target time point according to index file of the segment specifically includes:

determining start time information of the TS segment according to the duration information of the TS segment;

determining the TS segment corresponding to the time point of the time shifting according to the start time information of the TS segment.

Specifically, by taking the m3u8 index files as an example, a process of determining the TS segments corresponding to the target time point is illustrated below:

#EXTM3U

#EXT-X-TARGETDURATION:10

#EXT-X-MEDIA-SEQUENCE:0

#EXTINF:10,

https://priv.example.com/fileSequence0.ts

#EXTINF:10,

https://priv.example.com/fileSequence1.ts

#EXTINF:10,

https://priv.example.com/fileSequence2.ts

EXTM3U means a file header and is applicable to identifying; EXT-X-VERSION means protocol version; EXT-X-TARGETDURATION means the maximum duration of each TS segment; EXT-X-MEDIA-SEQUENCE means a serial number of the first TS segment in the current m3u8 index files, and each TS segment has an unique serial number in the m3u8 index files; EXTINF means the duration information of the TS segments; https://priv.example.com/fileSequence0.ts means URL (Uniform Resource Locator) corresponding to the No. 0 TS segment. The m3u8 index files include three TS segments, and the serial number of the TS segments is separately 0, 1 and 2.

According to the application example above, if the duration of each TS segment is 10 s, the start time of each TS segment can be calculated, for example, if the start time of the first TS segment is 0 s, then the start time of the second TS segment is 10 s, and the start time of the third TS segment is 30 s. It is supposed that the target time point is 25 s, and then the target time point is in the second TS segment.

Step 103: determining location information of key frame closest to the target time point in the TS segment.

Step 104: playing the TS segment from the location information of the key frame.

In specific applications, a video file is composed of I-frames (the key frames), P-frames and B-frames. Due to decode a video frame before playing the video, only the I-frames can be separately decoded and played. If a data frame corresponding to the target time point requested by the users is not the I-frames, the video file cannot be played; thus the location information of the I-frames closest to the target time point in the TS segments needs to be determined.

In order to quickly position the I-frames closest to the target time point, according to the embodiment of the present disclosure, in a process of slicing the streaming media files on the servers and generating the m3u8 index files, except recording the duration information of the segments, the start time information and the offset information of all I-frames are saved in the m3u8 index files. The terminal devices can download the m3u8 index files from the servers. In a process of parsing the m3u8 index files, the start time information and the offset information of the I-frames in each TS segment can be obtained.

According to an application example of the present disclosure, the start time information and the offset information of the I-frames can be defined in a manner of adding an extended field KEYFRAME behind description fields EXTINF of various segments in the m3u8 index files. Specifically, an application example of the m3u8 index files according to the present disclosure is shown as follows:

#EXTM3U

#EXT-X-VERSION:3

#EXT-X-TARGETDURATION:10

#EXT-X-MEDIA-SEQUENCE:0

#EXTINF:10,

#EXT-X-STREAM-INF:KEYFRAME=“0,56;3.32,153224;5.94, 683546”

https://priv.example.com/fileSequence0.ts

#EXTINF:10,

#EXT-X-STREAM-INF:KEYFRAME=“0,72;4.89,124532;6.82,356820”

https://priv.example.com/fileSequence1.ts

KEYFRAME is the extended field defined in the embodiment of the present disclosure and applicable to identifying the start time information and the offset information of the I-frames; for example, KEYFRAME can be defined as=“time, offset; time, offset; . . . ”, wherein time means the start time information of the I-frames, and offset means the offset information of the I-frames. According to the example above, the No. 0 TS segment includes three I-frames. For the first I-frame, the start time is 0 s, and the offset is 56; for the second I-frame, the start time is 4.89 s, and the offset is 124532; for the third I-frame, the start time is 6.82 s, and the offset is 356820.

According to an application example of the present disclosure, when the terminal devices are initialized, the m3u8 index files corresponding to the streaming media files to be played can be downloaded from the servers. When the terminal devices receive the time shifting instructions sent from the users, the TS segments corresponding to the target time point in the time shifting instructions as well as the start time information and the offset information of the I-frames closest to the target time point in the TS segments can be determined by parsing the m3u8 index files, namely playing the TS segments from the locations of the I-frames.

According to an application example of the present disclosure, it is supposed that the total duration of the streaming media files is 10 min, the durations of the TS segments are 10 s and the duration at target time point is 25 s, then the No. 1 TS segment (fileSequence1.ts) corresponding to the target time point can be found out according to the m3u8 index files, the start time of the TS segment is 20 s, and the TS segment includes three I-frames, wherein the start time of the second I-frame is 4.89 s, namely the start time of the second I-frame is 24.89 s and closest to the target time point, thus the TS segments is played from the location of the second I-frame. According to the embodiment of the present disclosure, the I-frames closest to the target time point can be directly positioned, rather than parsing and playing the TS segments from the head of the segment fileSequence1.ts, namely playing from the location at 20th second, thereby improving the accuracy of the time shifting and the efficiency of the time shifting.

According to a preferable embodiment of the present disclosure, the method further includes: detecting whether downloading the TS segment from the server before playing the TS segment from the location information of the key frame; if not, requesting to download the TS segment behind the location information of the key frame from the server.

According to specific applications, the terminal devices can send a HTTP (HyperText Transfer Protocol) request to the server, so as to request downloading the TS segments behind the location information of the key frame. HTTP protocol only supports requesting some part of some resource. Specifically, Range information can be added to the HTTP request, and the Range information is applicable to representing the resource range of the request. According to the embodiment of the present disclosure, the requested resource range is the TS segments behind the location information of the key frame, thus data downloaded from the server is corresponded to the target time point of the time shifting of the user, and the terminal device can directly play the video from the location, thereby not only improving the accuracy of the time shifting, but also reducing the loads of the server; and data undesirably obtained by the users does not transmitted.

In conclusion, according to the embodiment of the present disclosure, according to a time shifting point appointed by user, TS segment and location of key frame closest to the time shifting point in the TS segment can be determined according to the index files of the segment, thereby directly playing the TS segment from the location. According to the embodiment of the present disclosure, the TS segment can be directly played from the key frame closest to the time shifting point; as compared to play the TS segment from the head of the segment in prior art, the accuracy of the time shifting can be improved in a process of playing the streaming media file. In addition, according to the embodiment of the present disclosure, the key frame closest to a target time point can be directly positioned. The key frame can be separately decoded and played, rather than decoding from the head of the TS segment, thereby improving the decoding efficiency.

### Embodiment 2

FIG. 2 is a step flow chart of a method for processing streaming media according to a second embodiment of the present disclosure is shown in FIG. 2. The method for processing the streaming media specifically includes:

step 201: receiving time shifting instruction sent from user in a process of playing the streaming media, wherein the time shifting instruction include a target time point.

step 202: determining TS segment corresponding to a target time point according to index file of the segment corresponding to streaming media file.

step 203: parsing the index file of the segment to obtain start time information and offset information of all key frames in the TS segment.

step 204, determining the start time information and the offset information of the key frames closest to the target time point.

According to an application example of the present disclosure, the terminal devices can decode and play the streaming media files; in a process of parsing the m3u8 index files, when a field #EXT-X-STREAM-INF:KEYFRAME is parsed, the start time information and the offset information of various I-frames can be saved to a data structure list, each TS segment corresponds to a list, so as to quickly position the locations of the I-frames when carrying out time shifting, without parsing the m3u8 index files at each time shifting, thereby improving the efficiency of the time shifting. When users carry out time shifting operations, according to the target time point that the users carry out the time shifting and the m3u8 index files, the TS segment corresponding to the target time point can be found out, then the list corresponding to the segment can be found out, and then the start time information and the offset information of the closest I-frames can be found out according to the target time point, namely playing the streaming media files from the locations of the I-frame.

In addition, step 205 is included, which is: playing the TS segment from the location information of the key frame closest to the target time point.

According to the embodiment of the present disclosure, the start time information and the offset information of the key frames closest to the target time shifting point can be determined according to the start time information and the offset information of all the key frames in the TS segments obtained by parsing the index files of the segments, thereby directly playing the TS segments from the key frames closest to the target time point of time shifting. As compared to play the streaming media files from the heads of the segment head in prior art, the accuracy of the time shifting can be improved in a process of playing the streaming media files.

### Embodiment 3

Embodiment 1 and Embodiment 2 illustrate from the point of the terminal devices. In order to clearly illustrate the method for processing the streaming media disclosed in the present disclosure, a specific implementation process of the present disclosure is illustrated from the server side in a way that combines actual application scenarios.

According to the embodiments of the present disclosure, the streaming media files are transcoded and encapsulated on the server, and in the process, description information of the I-frames, including the start time information and offset information of the I-frames, are added according to customized protocols, so that when the streaming media files are played on clients, the accuracy of the time shifting can be improved.

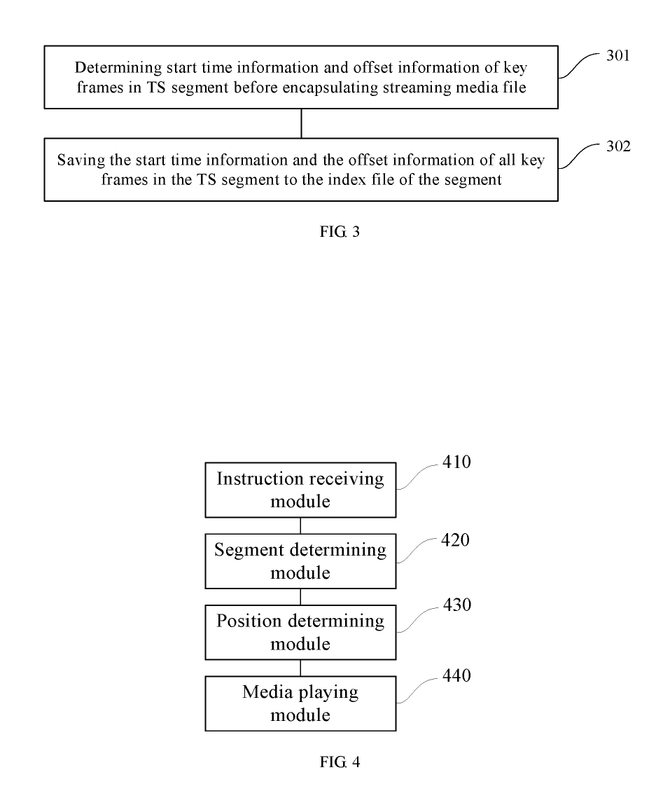

FIG. 3 is a step flow chart of a method for processing streaming media according to a third embodiment of the present disclosure is shown in FIG. 3. The method for processing the streaming media is applicable to servers, and specifically includes steps as follows.

Step 301: determining start time information and offset information of key frames in TS segment before encapsulating streaming media file.

Specifically, when videos are transcoded on servers, the start time information and the offset information of the I-frames of each TS segment of the videos can be recorded.

Step 302: saving the start time information and the offset information of the key frame in the TS segment to the index file of the segment.

Specifically, when the m3u8 index files are generated, the start time information and the offset information of all the I-frames can be integrated to the m3u8 index files, proprietary protocols can be defined, namely adding an extended field KEYFRAME=“time, offset; time, offset; . . . ”, wherein time means the start time information of the I-frame, and offset means the offset information of the I-frame.

According to the embodiment of the present disclosure, in a process of transcoding the streaming media files on the servers, the start time information and the offset information of the I-frames in each segment are marked in the generated m3u8 index files, so that when the terminal devices carry out the time shifting operations, corresponding I-frames can be directly located according to the m3u8 index files, thereby improving the accuracy of the time shifting.

### Device Embodiment

A structure diagram of a device for processing streaming media according to an embodiment of the present disclosure is shown in FIG. 4. The device for processing the streaming media specifically includes:

an instruction receiving module 410, used for receiving time shifting instruction sent from users in a process of playing the streaming media, wherein the time shifting instruction include a target time point;

a segment determining module 420, used for determining TS segment corresponding to a target time point according to index file of the segment corresponding to streaming media file;

a location determining module 430, used for determining location information of key frame closest to the target time point in the TS segment, and

a media playing module 440, used for playing the TS segments from the location information of the key frames.

According to a preferable embodiment of the present disclosure, the index files of the segment include: duration information of the TS segment.

The segment determining module 420 specifically includes:

a duration determining sub-module, used for determining start time information of the TS segment according to the duration information of the TS segment;

a segment determining sub-module, used for determining the TS segment corresponding to the time point of the time shifting according to the start time information of the TS segment.

According to anther preferable embodiment of the present disclosure, the index file of the segment include the start time information and the offset information of the key frame in the TS segment.

The location determining module 430 specifically includes:

a parsing sub-module, used for parsing the index file of the segment to obtain the start time information and the offset information of all key frames in the TS segment.

a determining sub-module, used for determining the start time information and the offset information of the key frame closest to the target time point.

According to the other preferable embodiment of the present disclosure, the device further includes:

a downloading module, used for detecting whether downloading the TS segment from the servers before playing the TS segment from the location information of the key frame; if not, requesting to download the TS segment behind the location information of the key frame from the server.

According to another preferable embodiment of the present disclosure, the device further includes:

a key frame information determining module, used for determining start time information and offset information of key frame in TS segment before encapsulating streaming media file;

a key frame information saving module, used for saving the start time information and the offset information of the key frame in the TS segments to the index file of the segment.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiments described above are schematic only, wherein units described as separate components can be or not be separated physically; components as unit display can be or not be physical units, namely located on a place or distributed to a plurality of network units. The purpose of the schemes in the embodiment can be achieved via partial or all modules according to actual requirements. A person skilled in the art can understand and implement without creative labor.

According to the descriptions of the embodiments above, a person skilled in the art can clearly understand that implementation methods can be achieved in a way that combines software and necessary general hardware platforms, or achieved via hardware. Based on this understanding, according to the technical schemes, essences or parts making a contribution to prior art are shown in a form of software products, the software products of computers can be saved to computer-readable memories, such as ROM/RAM (Read Only Memory/Random-Access Memory), diskettes, disks and the like, including a plurality of instructions so that computer equipment (a personal computer, a server or network equipment) implements embodiments or some parts of the embodiments.

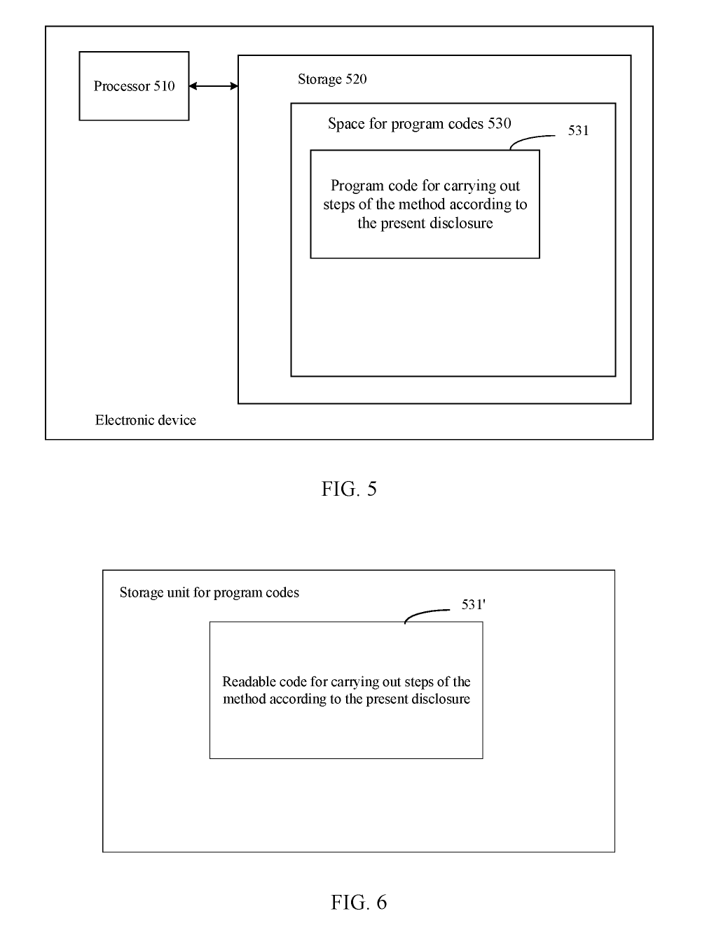

For example, FIG. 5 illustrates a block diagram of an electronic device for executing the method according the disclosure, the electronic device may be the server above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

Finally, it should be noted that the embodiments above are applicable to describe the technical schemes of the present disclosure only, rather than limiting the technical schemes. Though the present disclosure is described in details with the embodiments, a person skilled in the art shall understand that they can modify the technical schemes recorded in the embodiments, or equivalently replace partial technical characteristics, but the essences of the corresponding technical schemes do not depart from the spirit and scopes of the technical schemes in the embodiments of the present disclosure because of those modifications and replacements.

What is claimed is:

1. A method for processing streaming media, comprising:
at an electronic device:
receiving a time shifting instruction sent from a user in a process of playing a streaming media file, wherein the time shifting instruction comprises a target time point;
determining a TS segment corresponding to the target time point according to an index file of the segment corresponding to a streaming media file;
determining location information of a key frame closest to the target time point in the TS segment;
playing the TS segment from the location information of the key frame.

2. The method according to claim 1, wherein the index file of the segment comprises:
duration information of the TS segment;
the step of determining the TS segment corresponding to the target time point of time shifting according to index file of the segment comprises:
determining start time information of the TS segment according to the duration information of the TS segment;
determining the TS segment corresponding to the time point of the time shifting according to the start time information of the TS segment.

3. The method according to claim 1, wherein the index file of the segment comprises: the start time information and the offset information of the key frame in the TS segment;
the step of determining location information of key frame closest to the target time point in the TS segment comprises:
parsing the index file of the segment to obtain the start time information and the offset information of all key frames in the TS segment;
determining the start time information and the offset information of the key frame closest to the target time point.

4. The method according to claim 1, wherein the method further comprises:
detecting whether downloading the TS segment from a server before playing the TS segment from the location information of the key frame; if not, requesting to download the TS segment behind the location information of the key frame from the server.

5. The method according to claim 1, wherein the method further comprises:
determining start time information and offset information of the key frame in TS segment before encapsulating the streaming media file.
saving the start time information and the offset information of the key frame in the TS segment to the index file of the segment.

6. An electronic device, comprising:
at least one processor; and
a memory communicably connected with the at least one processor for storing instructions executable by the at least one processor, wherein execution of the instructions by the at least one processor causes the at least one processor to:
receive a time shifting instruction sent from a user in a process of playing a streaming media file, wherein the time shifting instruction comprises a target time point;
determine a TS segment corresponding to the target time point according to an index file of the segment corresponding to a streaming media file;
determine location information of a key frame closest to the target time point in the TS segment; and
play the TS segment from the location information of the key frame.

7. The electronic device according to claim 6, wherein the index file of the segment comprises: duration information of the TS segment;
determine the TS segment corresponding to the target time point according to the index file of the segment corresponding to the streaming media file comprises:
determine start time information of the TS segment according to the duration information of the TS segment;
determine the TS segment corresponding to the time point of the time shifting according to the start time information of the TS segment.

8. The electronic device according to claim 6, wherein the index file of the segment comprises: the start time information and the offset information of the key frame in the TS segment;
determine location information of a key frame closest to the target time point in the TS segment comprises:
parse the index file of the segment to obtain the start time information and the offset information of all key frames in the TS segment.
determine the start time information and the offset information of the key frame closest to the target time point.

9. The electronic device according to claim 6, wherein execution of the instructions by the at least one processor causes the at least one processor to further:
detect whether downloading the TS segment from a server before playing the TS segment from the location information of the key frame; if not, request to download the TS segment behind the location information of the key frame from the serve.

10. The electronic device according to claim 6, wherein execution of the instructions by the at least one processor causes the at least one processor to further:
determine start time information and the offset information of the key frame in TS segment before encapsulating the streaming media file;
save the start time information and the offset information of the key frame in the TS segment to the index file of the segment.

11. A non-transitory computer-readable medium storing executable instructions that, when executed by an electronic device, cause the electronic device to:
receive a time shifting instruction sent from a user in a process of playing a streaming media file, wherein the time shifting instruction comprises a target time point;
determine a TS segment corresponding to the target time point according to an index file of the segment corresponding to a streaming media file;
determine location information of a key frame closest to the target time point in the TS segment; and
play the TS segment from the location information of the key frame.

12. The non-transitory computer-readable medium according to claim 11, wherein the index file of the segment comprises: duration information of the TS segment;
determine the TS segment corresponding to the target time point according to the index file of the segment corresponding to the streaming media file comprises:
determine start time information of the TS segment according to the duration information of the TS segment;
determine the TS segment corresponding to the time point of the time shifting according to the start time information of the TS segment.

13. The non-transitory computer-readable medium according to claim 11, wherein the index file of the segment comprises: the start time information and the offset information of the key frame in the TS segment;
determine location information of a key frame closest to the target time point in the TS segment comprises:
parse the index file of the segment to obtain the start time information and the offset information of all key frames in the TS segment.
determine the start time information and the offset information of the key frame closest to the target time point.

14. The non-transitory computer-readable medium according to claim 11, wherein execution of the instructions by the at least one processor causes the at least one processor to further:
detect whether downloading the TS segment from a server before playing the TS segment from the location information of the key frame; if not, request to download the TS segment behind the location information of the key frame from the serve.

15. The non-transitory computer-readable medium according to claim 11, wherein execution of the instructions by the at least one processor causes the at least one processor to further:
determine start time information and the offset information of the key frame in TS segment before encapsulating the streaming media file;
save the start time information and the offset information of the key frame in the TS segment to the index file of the segment.
